(19) United States
(12) Patent Application Publication
(10) Pub. No.: US 2013/0020457 A1
(43) Pub. Date: Jan. 24, 2013

(54) ANTENNA MOUNTING MECHANISM

(71) Applicants: JU-SHAN LIN, Tu-Cheng (TW); TE-JEN SUNG, Tu-Cheng (TW); SHI-WEI SHI, Shenzhen City (CN)

(72) Inventors: JU-SHAN LIN, Tu-Cheng (TW); TE-JEN SUNG, Tu-Cheng (TW); SHI-WEI SHI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/228,466

(22) Filed: Sep. 9, 2011

(30) Foreign Application Priority Data
Jul. 22, 2011 (CN) 201110206465.9

(51) Int. Cl. H01Q 1/22

(52) U.S. Cl. 248/537

(57) ABSTRACT

An antenna mounting mechanism to mount an antenna to an electronic device is provided. The antenna mounting mechanism includes a rotatable frame capable of rotating about an axis and moving along the axis and along a direction parallel to the axis. The rotatable frame can attract antennas or cause the antennas to be disengaged from the rotatable frame with air or vacuum.

### BACKGROUND

1. Technical Field

The present disclosure relates to mounting mechanisms and, more particularly, to an antenna mounting mechanism.

2. Description of Related Art

Antennas are widely used in electronic devices, such as mobile phones, personal digital assistants (PDA). One way to mount an antenna to an electronic device is to use screws to connect the antenna to the electronic device. Another way to mount an antenna is to use mechanical locking mechanisms. For such mechanical locking mechanisms, a new antenna mounting mechanism is needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view showing an antenna mounting mechanism mounting an antenna to an electronic device in accordance with an exemplary embodiment.

FIG. 2 is an isometric view of a portion of the antenna mounting mechanism of FIG. 1.

FIG. 3 is an enlarged view of a portion III of FIG. 1.

FIG. 4 is a schematic view showing the antenna being mounted to the electronic device of FIG. 1.

### DETAILED DESCRIPTION

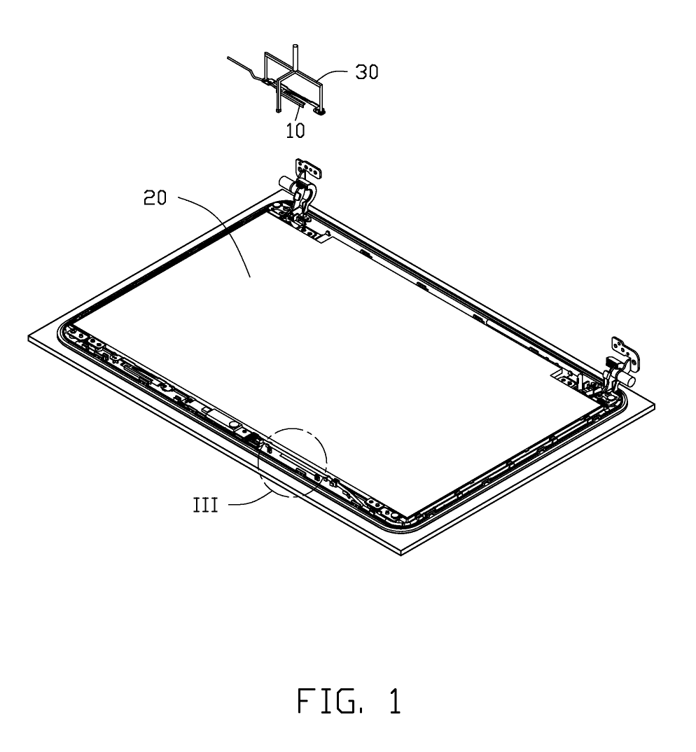

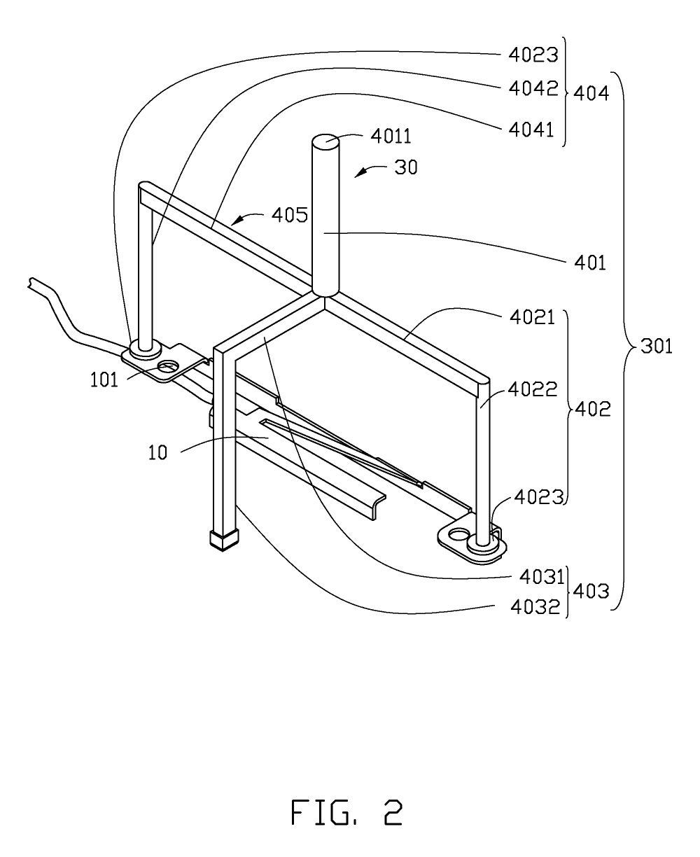

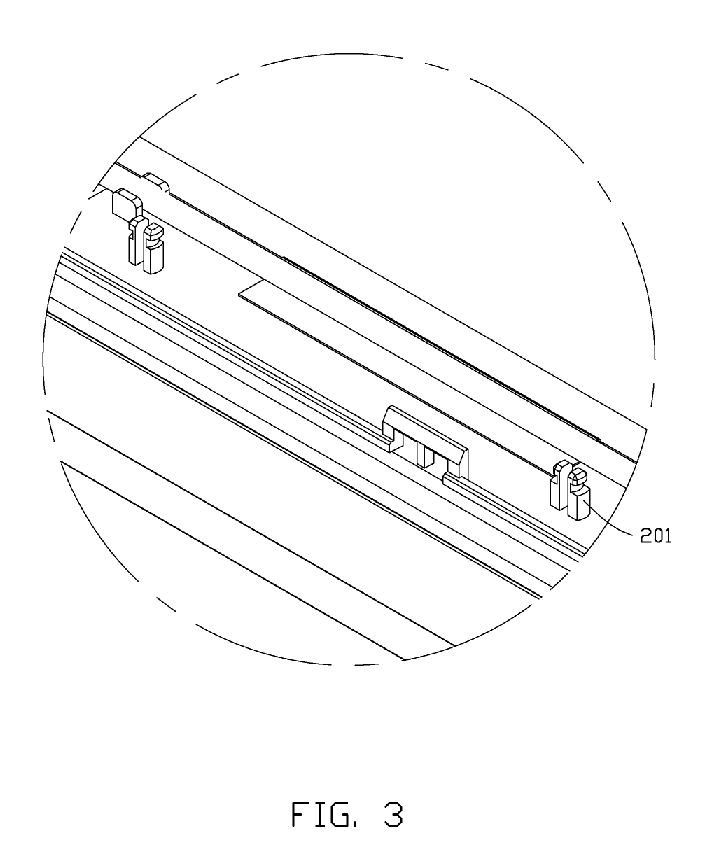

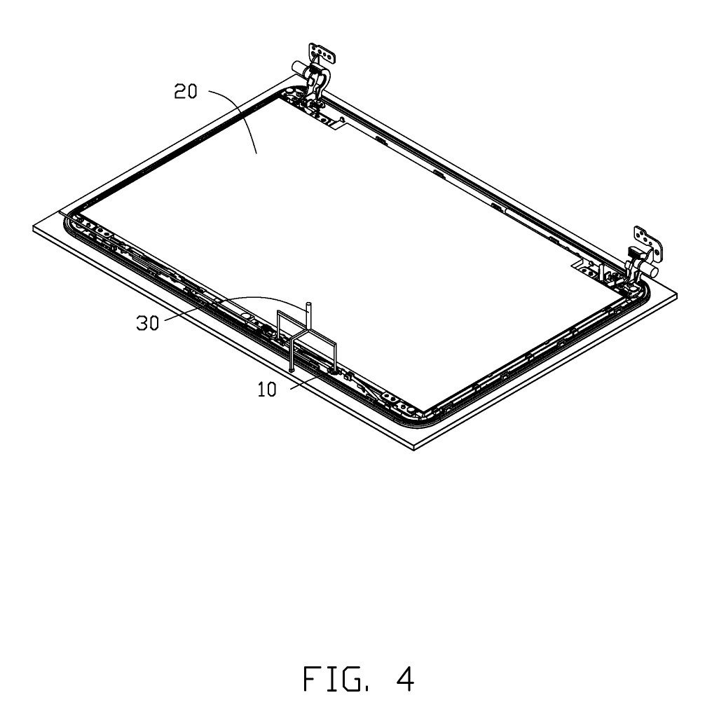

Referring to FIGS. 1-4, an antenna mounting mechanism 30 mounts an antenna 10 to an electronic device 20. The electronic device 20 has communication functions, such as a mobile phone or a notebook. The antenna mounting mechanism 30 includes a rotatable frame 301. The rotatable frame 301 can rotate about an axis and move along the axis and along a direction parallel to the axis. In this embodiment, the rotation and the movement of the rotatable frame 301 are controlled by a numerical control machine tool (not shown).

The rotatable frame 301 includes a body 401, a first arm 402, and a second arm 403. The first arm 402 includes a first connection bar 4021 and a first absorption bar 4022 connected to the connection bar 4021. The first absorption bar 4022 is hollow. The second arm 403 includes a second connection bar 4031 and a push bar 4032 connected to the second connection bar 4031. One end of each of the connection bars 4021, 4031 is connected to one end of the body 401. In this embodiment, the absorption bar 4022 is substantially perpendicularly connected to the connection bar 4021, and the push bar 4032 is substantially perpendicularly connected to the connection bar 4031. The connection bars 4021, 4031 are substantially perpendicular to the body 401.

A suction cup 4023 is arranged on the free end of the absorption bar 4022 to attract the antenna 10. When the absorption bar 4022 is moved to be above the antenna 10 and air in the absorption bar 4022 is vented, the antenna 10 can be attracted to the suction cup 4023. When the antenna 10 is moved to a preset position on the electronic device 20 and air is injected into the absorption bar 4022, the antenna 10 can be disengaged from the suction cup 4023 to be placed on a preset position.

After the rotatable frame 301 is rotated to a position where the push bar 4032 of the second arm 403 is located above the antenna 10, the rotatable frame 301 is moved downward to cause the push bar 4032 to push the antenna 10 until the antenna 10 is locked to the device 20. In this embodiment, a number of through holes 101 are arranged on the antenna 10, and a number of locking bars 201 are arranged at preset locations on the device 20. When the push bar 4032 pushes the antenna 10, the top ends of the corresponding locking bars 201 are deformed and pressed into the through holes 101. After the top ends of the corresponding locking bars 201 rebound, the antenna 10 is locked to the electronic device 20.

In this embodiment, a top end 4011 of the body 401 is connected to an air pump. The body 401 and the connection bar 4021 of the first arm 402 are hollow. The body 401, the connection bar 4021, and the absorption bar 4022 are in communication with each other, thereby allowing air in the absorption bar 4022 to be vented, allowing air to be injected into the absorption bar 4022 from the top end 4011 through the air pump.

The rotatable frame 301 further includes a third arm 404. The third arm 404 includes a third connection bar 4041 and a second absorption bar 4042 connected to the third connection bar 4041. The third connection bar 4041 and the second absorption bar 4042 are hollow. One suction cup 4023 is arranged on the free end of the absorption bar 4042. One end of the connection bar 4041 is connected to the connection position between the connection bar 4021 of the first arm 402 and the body 4041. The connection bar 4041, the connection bar 4021, and the body 401 are in communication with each other. When air is vented from the top end 4011, both of the suction cups 4023 on the absorption bar 4022 and 4023 can attract the antenna 10. In this embodiment, the absorption bar 4042 is substantially perpendicularly connected to the connection bar 4041, and the connection bar 4021 and the connection bar 4041 are connected to form a straight bar 405.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An antenna mounting mechanism to mount an antenna to an electronic device, comprising:
a rotatable frame the rotatable frame comprising:
a body;
a first arm comprising a first connection bar and a first absorption bar connected to the first connection bar, one end of the first connection bar being connected to one end of the body, the first absorption bar being hollow, a suction cup being arranged on one end of the first absorption bar to attract the antenna; and
a second arm comprising a second connection bar and a push bar connected to the second connection bar, one end of the second connection bar being connected to the one end of the body, the push bar being configured to push the antenna, wherein when air in the first absorption bar is vented, the suction cup is capable of attracting the antenna, and the antenna attracted by the suction cup disengages from the suction cup when air is injected into the first absorption bar.

2. The antenna mounting mechanism as described in claim 1, wherein the body and the first connection bar are hollow, the body, the first connection bar, the first absorption bar are in communication with each other, and air in the absorption bar is capable of being vented or air is capable of being injected into the absorption bar from an opposite end of the body.

3. The antenna mounting mechanism as described in claim 2, wherein the first absorption bar is substantially perpendicularly connected to the first connection bar, the push bar is substantially perpendicularly connected to the second connection bar, and the first connection bar and the second connection bar are substantially perpendicular to the body.

4. The antenna mounting mechanism as described in claim 1, wherein the rotatable frame further comprises a third arm, the third arm comprises a third connection bar and a second absorption bar connected to the third connection bar, the third connection bar and the second absorption bar are hollow, one suction cup is arranged on one end of the second absorption bar, one end of the third connection bar is connected to the connection position between the first connection bar and the body.

5. The antenna mounting mechanism as described in claim 4, wherein the second absorption bar is substantially perpendicularly connected to the third connection bar, and the third connection bar and the first connection bar are connected to form a straight bar.
